(19) United States
(12) Patent Application Publication
(10) Pub. No.: US 2025/0308762 A1
(43) Pub. Date: Oct. 2, 2025

(54) MULTILAYER COIL COMPONENT

(71) Applicant: TDK Corporation, Tokyo (JP)

(72) Inventors: Yuto SHIGA, Tokyo (JP); Teru ISHIMORI, Tokyo (JP); So KOBAYASHI, Tokyo (JP); Hiroto KOMATSU, Tokyo (JP)

(73) Assignee: TDK Corporation, Tokyo (JP)

(21) Appl. No.: 19/082,482

(22) Filed: Mar. 18, 2025

(30) Foreign Application Priority Data
Mar. 29, 2024 (JP) 2024-056803

(51) Int. Cl. H01F 27/34; H01F 17/00

(52) U.S. Cl. CPC H01F 27/34; H01F 17/0013

(57) ABSTRACT

A multilayer coil component includes an element body, a coil in the element body, and an external electrode exposed on the element body. The coil includes a plurality of coil conductors each having a thickness and a path length. The external electrode is electrically connected to the coil. The plurality of coil conductors includes a first coil conductor, a second coil conductor, and a third coil conductor arranged in a direction and adjacent to each other. The second coil conductor has a path length shorter than the path length of each of the first coil conductor and the third coil conductor and has a thickness larger than the thickness of at least one of the first coil conductor and the second coil conductor.

### CROSS-REFERENCE TO RELATED APPLICATIONS

This application is based upon and claims the benefit of priority from Japanese Patent Application No. 2024-056803, filed On Mar. 29, 2024, the entire contents of which are incorporated herein by reference.

### BACKGROUND

### Field

The present disclosure relates to a multilayer coil component.

### Description of the Related Art

A multilayer coil component including an element body and a coil in the element body is known (for example, Japanese Unexamined Patent Publication No. 2018-113309). The coil includes a plurality of coil conductors electrically connected to each other.

### SUMMARY

An object of one aspect of the present disclosure is to provide a multilayer coil component capable of improving a self-resonant frequency.

The multilayer coil component according to one aspect of the present disclosure includes an element body, a coil in the element body, and an external electrode on the element body. The coil includes a plurality of coil conductors each having a thickness and a path length. The external electrode is electrically connected to the coil. The plurality of coil conductors includes a first coil conductor, a second coil conductor, and a third coil conductor arranged in a direction and adjacent to each other. The second coil conductor has a path length shorter than the path length of each of the first coil conductor and the third coil conductor and has a thickness larger than the thickness of at least one of the first coil conductor and the third coil conductor.

The self-resonant frequency of a multilayer coil component changes according to stray capacitance between the plurality of coil conductors included in the coil. The stray capacitance generated between the plurality of coil conductors increases, the self-resonant frequency of the multilayer coil component decreases. The stray capacitance is proportional to an area of two conductors facing each other and is inversely proportional to an interval between two conductors facing each other. Therefore, in the plurality of coil conductors, the stray capacitance correlates with the path length of each coil conductor and the interval between the two coil conductors.

In a multilayer coil component, a plurality of inductance values are required for a predetermined outer shape size. Since the inductance value depends on the number of turns of the coil, a path length of each of the plurality of coil conductors included in the coil tends not to be a constant value. Between the plurality of coil conductors having a longer path length than the other coil conductors, a stray capacitance larger than the stray capacitance generated between the other coil conductors is generated.

In the one aspect, the second coil conductor has the path length shorter than the path length of each of the first coil conductor and the third coil conductor, and is located between the first coil conductor and the third coil conductor in the plurality of coil conductors. Since the first coil conductor and the third coil conductor have the path length longer than the path length of the second coil conductor, the stray capacitance generated between the first coil conductor and the third coil conductor is larger than the stray capacitance generated between the first coil conductor and the third coil conductor having other configurations. The interval between the first coil conductor and the third coil conductor changes based on the thickness of the second coil conductor. The second coil conductor has a thickness larger than a thickness of at least one of the first coil and the third coil. The stray capacitance generated in the coil of the one aspect is smaller than the stray capacitance generated in the coil having a configuration in which the second coil has a thickness equal to or less than both the thickness of the first coil and the thickness of the third coil. As a result, in the one aspect, the self-resonant frequency of the multilayer coil component can be improved.

The present disclosure will become more fully understood from the detailed description given hereinafter and the accompanying drawings which are given by way of illustration only, and thus are not to be considered as limiting the present disclosure.

Further scope of applicability of the present disclosure will become apparent from the detailed description given hereinafter. However, it should be understood that the detailed description and specific examples, while indicating examples of the disclosure, are given by way of illustration only, since various changes and modifications within the spirit and scope of the disclosure will become apparent to those skilled in the art from this detailed description.

### BRIEF DESCRIPTION OF THE DRAWINGS

FIG. 1 is a perspective view of a multilayer coil component according to an embodiment;

FIG. 2 is a perspective view of a coil according to the present embodiment;

FIG. 3 is a plan view of the coil according to the present embodiment as viewed from a side surface;

FIG. 4 is a plan view of the coil according to the present embodiment as viewed from a side surface;

FIG. 5 is a plan view of the coil according to the present embodiment as viewed from a main surface;

FIG. 6 is an exploded view illustrating a configuration of the multilayer coil component according to the present embodiment;

FIG. 7 is a plan view of a first coil conductor according to the present embodiment;

FIG. 8 is a plan view of a second coil conductor according to the present embodiment;

FIG. 9 is a plan view of a third coil conductor according to the present embodiment;

FIG. 10 is a perspective view of the multilayer coil component according to a modification of the present embodiment;

FIG. 11 is a perspective view of a coil according to the modification of the present embodiment;

FIG. 12 is a plan view of the coil according to the modification of the present embodiment as viewed from a side surface;

FIG. 13 is a plan view of the coil according to the modification of the present embodiment as viewed from a main surface;

FIG. 14 is a plan view of the coil according to the modification of the present embodiment as viewed from a main surface;

FIG. 15 is an exploded view illustrating a configuration of a multilayer coil component according to the modification of the present embodiment;

FIG. 16 is a plan view of a first coil conductor according to the modification;

FIG. 17 is a plan view of a second coil conductor according to the modification; and

FIG. 18 is a plan view of a third coil conductor according to the modification.

### DETAILED DESCRIPTION

Hereinafter, examples of the present disclosure will be described in detail with reference to the accompanying drawings. In the following description, the same elements or elements having the same functions are denoted with the same reference numerals and overlapped explanation is omitted.

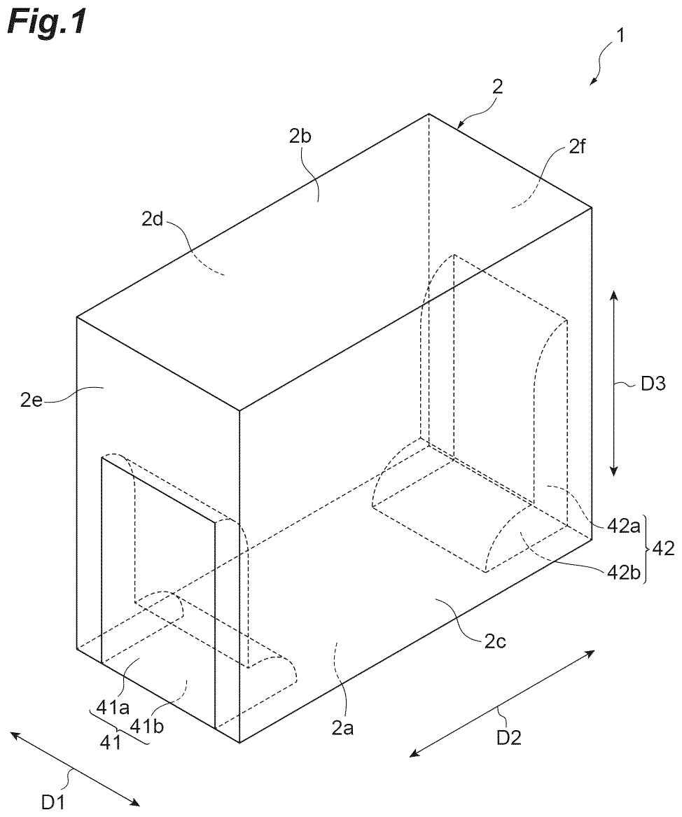

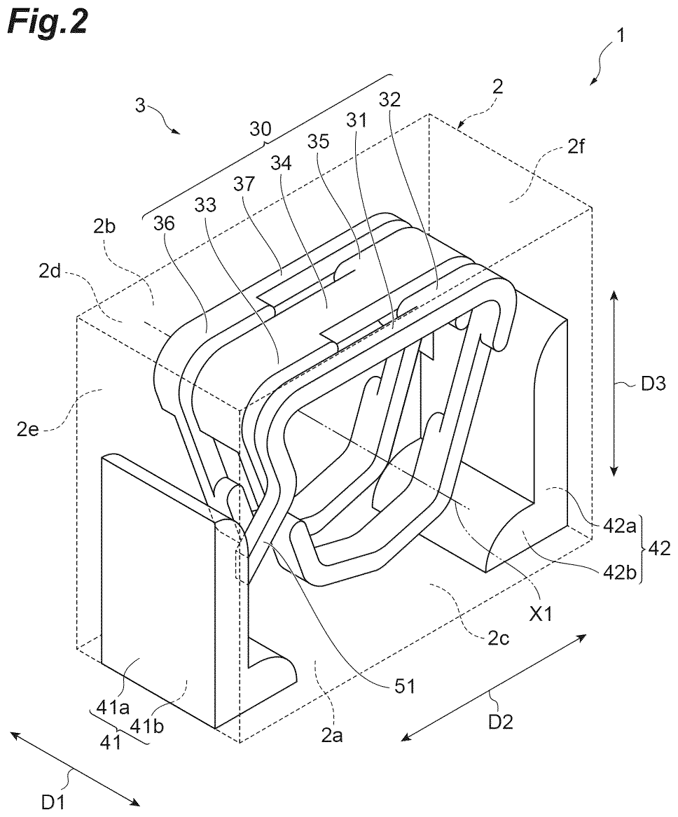

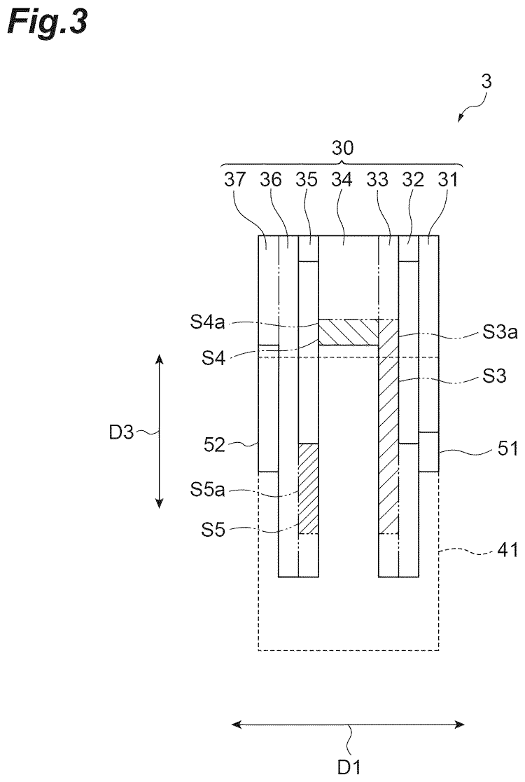

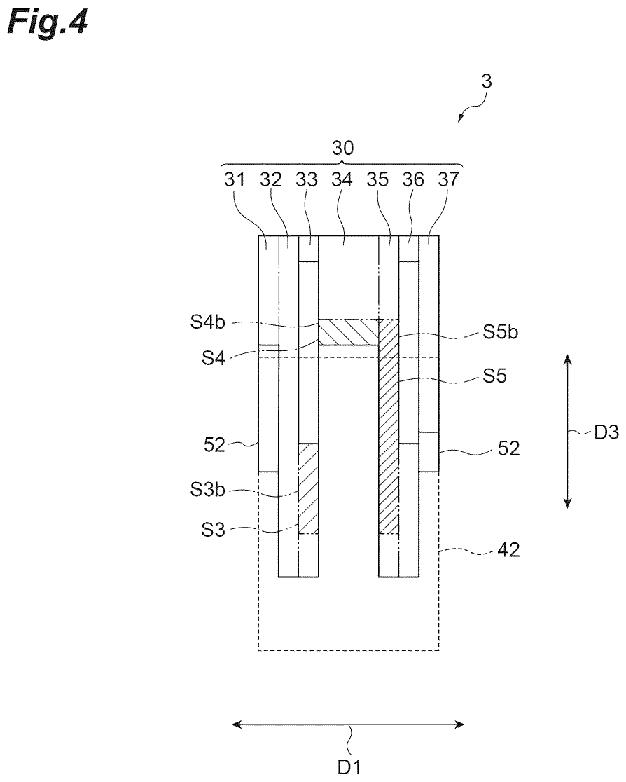

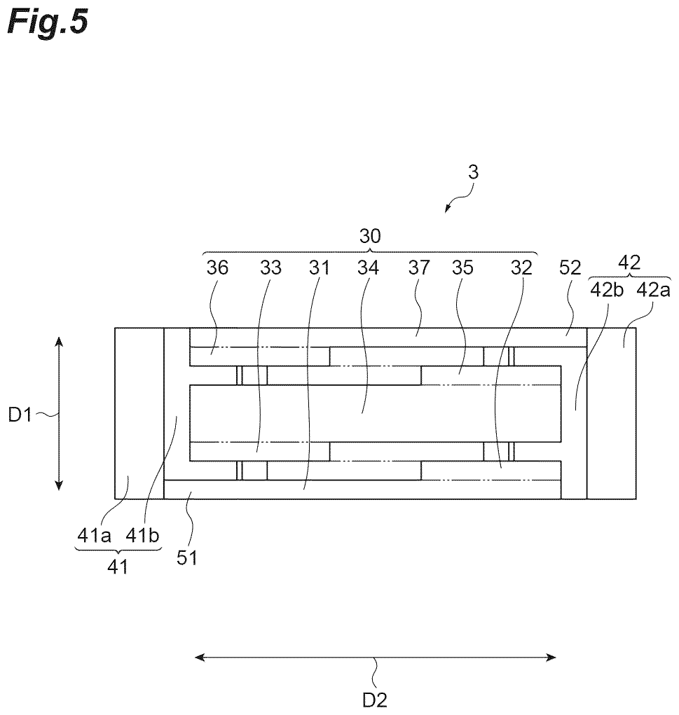

With reference to FIGS. 1 to 5, the configuration of the multilayer coil component 1 according to the present embodiment will be described. FIG. 1 is the perspective view of the multilayer coil component according to the present embodiment. FIG. 2 is the perspective view of the coil according to the present embodiment. FIG. 3 is the plan view of the coil according to the present embodiment as viewed from a side surface 2e illustrated in FIG. 1. FIG. 4 is the plan view of the coil according to the present embodiment as viewed from a side surface 2f illustrated in FIG. 1. FIG. 5 is the plan view of the coil according to the present embodiment as viewed from a main surface 2b illustrated in FIG. 1. The multilayer coil component 1 according to the present embodiment is solder-mounted to an electronic device. The electronic device includes, for example, a circuit board or an electronic component.

As illustrated in FIGS. 1 and 2, the multilayer coil component 1 includes an element body 2, the coil 3 in the element body 2, a pair of external electrodes 41 and 42 on surfaces of the element body 2, and a pair of connection conductors 51 and 52 in the element body 2. The external electrodes 41 and 42 are electrically connected to the coil 3. The element body 2 has a rectangular parallelepiped shape. The rectangular parallelepiped shape includes a rectangular parallelepiped shape in which corner and ridge are chamfered, or a rectangular parallelepiped shape in which corner and ridge are rounded.

The element body 2 includes a pair of main surfaces 2a and 2b, a pair of side surfaces 2c and 2d, and a pair of side surfaces 2e and 2f. The pair of main surfaces 2a and 2b oppose each other. The pair of side surfaces 2c and 2d oppose each other. The pair of side surfaces 2e and 2f oppose each other. The main surfaces 2a and 2b are adjacent to the side surfaces 2c and 2d and the side surfaces 2e and 2f. The side surfaces 2c and 2d are each adjacent to the side surfaces 2e and 2f. When the multilayer coil component 1 is solder-mounted on the electronic device, the main surface 2a faces the electronic device to be solder-mounted. The main surfaces 2a and 2b, the side surfaces 2c and 2d, and the side surfaces 2e and 2f are flat surfaces. The flat surface means a surface formed so as to be a flat surface and is not limited to a geometrically complete flat surface. The flat surface may include curvature and unevenness that occur in a manufacturing process.

A direction D3 in which the pair of main surfaces 2a and 2b oppose each other is orthogonal to each of the main surfaces 2a and 2b. A direction D1 in which the pair of side surfaces 2c and 2d oppose each other is orthogonal to each of the side surfaces 2c and 2d. A direction D2 in which the pair of side surfaces 2e and 2f oppose each other is orthogonal to each of the side surfaces 2e and 2f. The direction D3 is orthogonal to the direction D1 and the direction D2. The direction D1 and the direction D2 are orthogonal to each other. A pair of recesses corresponding to the pair of external electrodes 41 and 42 is formed in the element body 2.

The external electrodes 41 and 42 have L-shaped cross sections when viewed from the direction D1. The recesses corresponding to the external electrodes 41 and 42 formed in the element body 2 have L shapes when viewed from the direction D1. The external electrode 41 includes a portion 41a and a portion 41b. A surface of the portion 41a is oriented in the same orientation as the side surface 2e, and a surface of the portion 41b is oriented in the same orientation as the main surface 2a. The portion 41a and the portion 41b are continuous along a ridge portion between the side surface 2e and the main surface 2a. The external electrode 42 includes a portion 42a and a portion 42b. A surface of the portion 42a is oriented in the same orientation as the side surface 2f, and a surface of the portion 42b is oriented in the same orientation as the main surface 2a. The portion 42a and the portion 42b are continuous along a ridge portion between the side surface 2f and the main surface 2a. A main surface 2a includes a surface defining a recess corresponding to portions 41b and 42b. A side surface 2e includes a surface defining a recess corresponding to a portion 41a. A side surface 2f includes a surface defining a recess corresponding to a portion 42a. An external electrode 41 is on the main surface 2a and the side surface 2e. An external electrode 42 is on the main surface 2a and the side surface 2f.

In the present embodiment, lengths of the external electrodes 41 and 42 in the direction D3 are longer than lengths of the external electrodes 41 and 42 in the direction D2. The portions 41b and 42b are disposed to be exposed in the same orientation as the main surface 2a. Surfaces of the portions 41b and 42b and the main surface 2a may be located on the same flat surface. The surfaces of the portions 41b and 42b may protrude from the main surface 2a. The portion 41a is disposed to be exposed in the same orientation as the side surface 2e. The surface of the portion 41a and the side surface 2e may be located on the same flat surface. The surface of the portion 41a may protrude from the side surface 2e. The portion 42a is disposed on the side surface 2f to be exposed in the same orientation as the side surface 2f. The surface of the portion 42a and the side surface 2f may be located on the same surface. The surface of the portion 42a may protrude from the side surface 2f. In the present embodiment, lengths of the portions 41a and 42a in the direction D3 are longer than lengths of the portions 41b and 42b in the direction D2.

As illustrated in FIGS. 2 to 5, a coil 3 includes a plurality of coil conductors 30. The plurality of coil conductors 30 are electrically connected to each other. The plurality of coil conductors 30 includes coil conductors 31, 32,33,34,35, 36 and 37. The coil conductors 31 to 37 are arranged in this order (the coil conductor 31, the coil conductor 32, the coil conductor 33, the coil conductor 34, the coil conductor 35, the coil conductor 36, the coil conductor 37) along the direction D1 and are adjacent to each other. The coil conductor 31 is an endmost coil conductor including one end of the coil 3 in the direction D1. The coil conductor 37 is an endmost coil conductor including the other end of the coil 3 in the direction D1. The coil 3 includes seven coil conductors 31 to 37 coupled in the direction D1. The number of turns of the coil 3 is 2.5. Each of the coil conductors 31 to 37 constitutes a part of an annular track centered on a coil axis X1 in the coil 3. Each of the coil conductors 31 to 37 has, for example, a shape in which a part of a loop is interrupted. The plurality of coil conductors 30 each has a path length and a thickness.

The respective coil conductors 31 to 37 includes a first end and a second end. The first end corresponds to one end in the shape in which the part of the loop is interrupted. The second end corresponds to the other end in the shape in which the part of the loop is interrupted. The respective coil conductors 31 to 37 extends along paths from the first ends to the second ends in respective layers of the coil conductors 31 to 37. Lengths of the paths from the first ends to the second ends of the respective coil conductors 31 to 37 are referred to as path lengths of the respective coil conductors 31 to 37, respectively. The path length may be the minimum length from an end surface of a first end to an end surface of a second end of the respective coil conductors 31 to 37. For example, the path length may be an inner circumference from the first end surface to the second end surface of the respective coil conductor 31 to 37. Each layer of the coil conductors 31 to 37 corresponds to each layer constituting the multilayer coil component 1. Each layer of the coil conductors 31 to 37 extends along a flat surface intersecting the direction D1 in which the coil conductors 31 to 37 are arranged. In the present embodiment, each layer of the coil conductors 31 to 37 extends along the direction D2 and the direction D3.

The coil conductors 33, 34, and 35 are arranged in the direction D1 in the order of the coil conductor 33, the coil conductor 34, and the coil conductor 35. The coil conductor 33 and the coil conductor 34 are adjacent to each other, and the coil conductor 34 and the coil conductor 35 are adjacent to each other. The coil conductor 34 is located between the coil conductor 33 and the coil conductor 35 in the plurality of coil conductors 30. The coil conductor 33 and the coil conductor 35 are separated from each other by the thickness of the coil conductor 34 in the direction D1. Each of the coil conductor 33 and the coil conductor 35 includes a portion facing each other at a distance of the thickness of the coil conductor 34 in the direction D1. For example, the coil conductor 33 is defined as a first coil conductor, the coil conductor 34 is defined as a second coil conductor, and the coil conductor 35 is defined as a third coil conductor.

Widths of the respective coil conductors 31 to 37 in a direction orthogonal to paths of the respective coil conductors 31 to 37 are equal to each other. In the present specification, the term “equal” does not necessarily mean that values coincide with each other. Even in a case where values include slight differences, manufacturing errors, or measurement errors within a preset range, the values may be regarded as being equal to each other.

The thicknesses of the coil conductors 31, 32, 33, 35, 36, and 37 are equal to each other. In the present specification, the “thickness” of the coil conductor is a distance between one surface of the coil conductor in the direction D1 and the other surface located opposite to the one surface. The average distance between one surface and the other surface of the coil conductor in the direction D1 may be set as the thickness of the coil conductor. In one example, the distance between one surface facing the adjacent coil conductor at the first end of the coil conductor and the other surface facing another adjacent coil conductor at the second end of the coil conductor may be the thickness of the coil conductor.

The coil conductor 34 has a thickness larger than the thickness of the coil conductors 33 and 35. The coil conductor 34 may have a thickness larger than the thickness of at least one of the coil conductor 33 and the coil conductor 35. The coil conductor 34 has a thickness that is 1.25 times or more than the thickness of the coil conductors 33 and 35. The coil conductor 34 may have a thickness that is twice or more than the thickness of the coil conductors 33 and 35, or may have a thickness that is three times or more than the thickness of the coil conductors 33 and 35. The coil conductor 34 may have the largest thickness among the plurality of coil conductors 30. The coil conductors 33 and 35 may have the smallest thickness among the plurality of coil conductors 30.

Ends of a pair of coil conductors adjacent to each other among the plurality of coil conductors 30 overlap each other and are coupled to each other. In the present embodiment, the ends of a pair of coil conductors adjacent to each other among the plurality of coil conductors 30 completely overlap each other. However, the ends may at least partially overlap each other. The coil conductors 31 and 32, the coil conductors 32 and 33, the coil conductors 33 and 34, the coil conductors 34 and 35, the coil conductors 35 and 36, and the coil conductors 36 and 37 are a pair of coil conductors adjacent to each other in the direction D1. For example, the second end of the coil conductor 31 and the first end of the coil conductor 32 overlap each other in the direction D1 and are coupled to each other. A pair of coil conductors adjacent to each other among the plurality of coil conductors 30 is directly and physically connected to each other at each end.

The connection conductor 51 connects the coil 3 and the external electrode 41 to each other. The coil 3 and the external electrode 41 are electrically and physically connected to each other via the connection conductor 51. The connection conductor 51 is continuous with the coil conductor 31 in the same layer as the coil conductor 31. The connection conductor 51 extends between the first end of the coil conductor 31 and the portion 41a of the external electrode 41. A thickness of the connection conductor 51 is equal to the thickness of the coil conductor 31. The connection conductor 52 connects the coil 3 and the external electrode 42 to each other. The coil 3 and the external electrode 42 are electrically and physically connected to each other via the connection conductor 52. The connection conductor 52 is continuous with the coil conductor 37 in the same layer as the coil conductor 37. The connection conductor 52 extends between the second end of the coil conductor 37 and the portion 42a of the external electrode 42. A thickness of the connection conductor 52 is equal to the thickness of the coil conductor 37. Respective thicknesses of the connection conductor 51 and the connection conductor 52 are equal to each other.

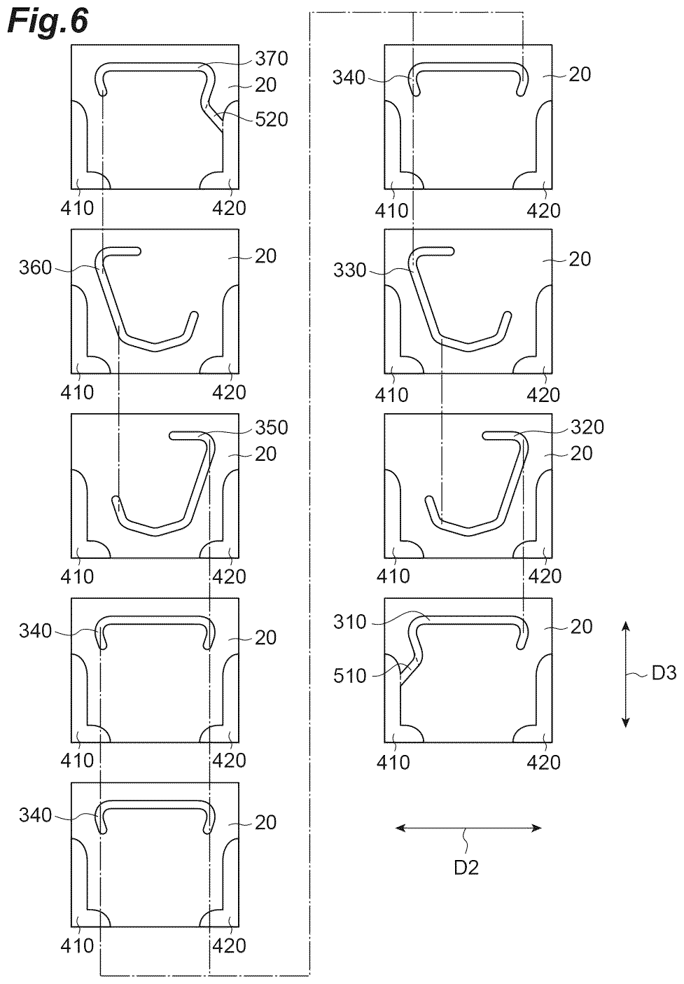

FIG. 6 is an exploded view illustrating a configuration of the multilayer coil component 1 according to the present embodiment. In the present embodiment, a lamination direction of the multilayer coil component 1 is along the direction D1. FIG. 6 illustrates a plurality of layers constituting the multilayer coil component 1 as viewed from the direction D1. The plurality of layers constituting the multilayer coil component 1 includes a layer constituting the element body 2, a layer constituting the coil 3, layers constituting the external electrodes 41 and 42, and layers constituting the connection conductors 51 and 52. Thicknesses of the plurality of layers are equal to each other. Hereinafter, with reference to FIG. 6, the element body 2, the plurality of coil conductors 30 of the coil 3, the external electrodes 41 and 42, and the connection conductors 51 and 52 will be described.

The element body 2 includes a plurality of laminated insulator layers 20. In the present embodiment, the number of the plurality of insulator layers 20 is “13”. FIG. 6 illustrates nine insulator layers 20 while two insulator layers 20 located at each end in the direction D1 are omitted. In the actual element body 2, the respective insulator layers 20 are integrated to such an extent that boundaries between the insulator layers 20 cannot be visually recognized. Each of the insulator layers 20 includes, for example, a nonmagnetic material. The nonmagnetic material includes, for example, a glass ceramic material or a dielectric material. In the present embodiment, each insulator layer 20 includes a sintered body of a green sheet including a nonmagnetic material. Each of the insulator layers 20 may include, for example, a magnetic material.

The external electrode 41 and the external electrode 42 include a plurality of laminated electrode layers 410 and a plurality of laminated electrode layers 420, respectively. In the present embodiment, the number of the plurality of electrode layers 410 and the number of the plurality of electrode layers 420 are each “9”. In the actual external electrode 41, the respective electrode layers 410 are integrated to such an extent that boundaries between the electrode layers 410 cannot be visually recognized. In the actual external electrode 42, the respective electrode layers 420 are integrated to such an extent that boundaries between the electrode layers 420 cannot be visually recognized. Each of the electrode layers 410 and 420 is provided in a defective portion formed in the corresponding insulator layers 20. A pair of recesses corresponding to the external electrodes 41 and 42 is obtained by the defective portions formed in the respective insulator layers 20. Each of the electrode layers 410 and 420 includes, for example, a conductive material. The conductive material includes, for example, Ag or Pd. In the present embodiment, each of the electrode layers 410 and 420 includes a sintered body of a conductive paste including powder of the conductive material.

The connection conductor 51 and the connection conductor 52 include an electrode layer 510 and an electrode layer 520, respectively. The electrode layer 510 is continuous with a coil conductor layer 310, and the electrode layer 520 is continuous with a coil conductor layer 370. Each of the electrode layers 510 and 520 is provided in a defective portion formed in the corresponding insulator layer 20. Each of the electrode layer 510 and 520 includes, for example, the same material as that of each of the electrode layers 410 and 420. Each of the electrode layers 510 and 520 includes, for example, a sintered body of a conductive paste.

The plurality of coil conductors 30 includes a plurality of coil conductor layers corresponding to each of the plurality of coil conductors 30. The coil conductor 31 includes the coil conductor layer 310. The coil conductor 32 includes a coil conductor layer 320. The coil conductor 33 includes a coil conductor layer 330. The coil conductor 34 includes a plurality of coil conductor layers 340 that entirely overlap each other. In the present embodiment, the number of the plurality of coil conductor layers 340 is “3”. The coil conductor 35 includes a coil conductor layer 350. The coil conductor 36 includes a coil conductor layer 360. The coil conductor 37 includes the coil conductor layer 370.

In the coil conductor 34 of the actual coil 3, each of the coil conductor layers 340 is integrated to such an extent that boundaries between each of the coil conductor layers 340 cannot be visually recognized. Each of the coil conductor layers 310 to 370 is provided in a defective portion formed in the corresponding insulator layer 20. Each of the coil conductor layers 310 to 370 includes, for example, the same material as that of each of the electrode layers 410 and 420. Each of the coil conductor layers 310 to 370 includes, for example, a sintered body of a conductive paste.

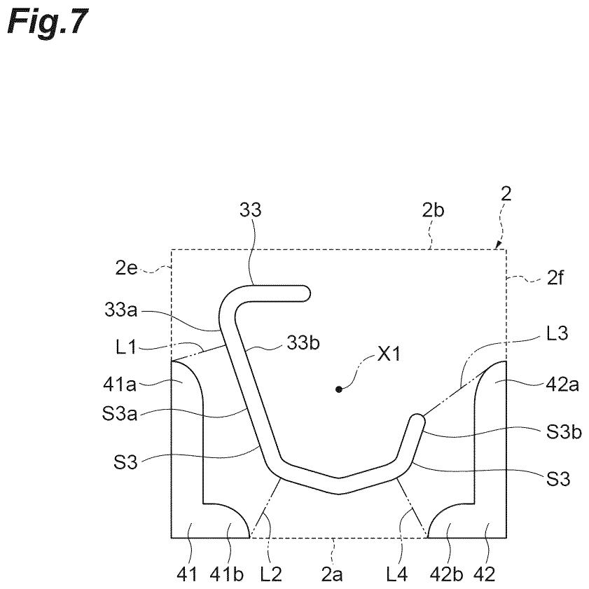

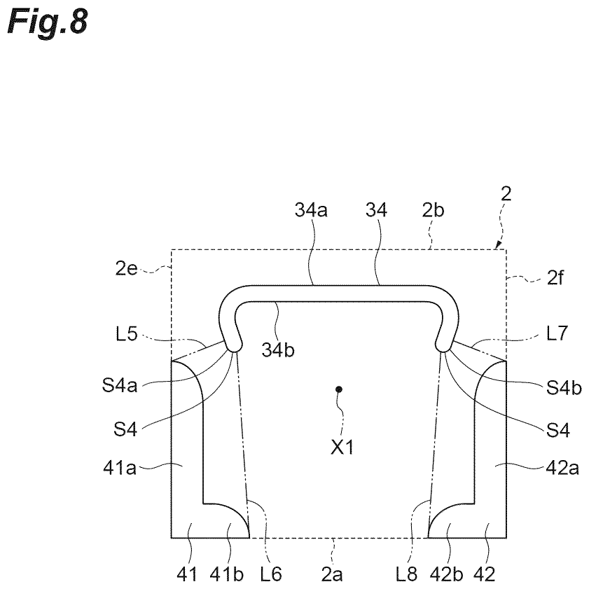

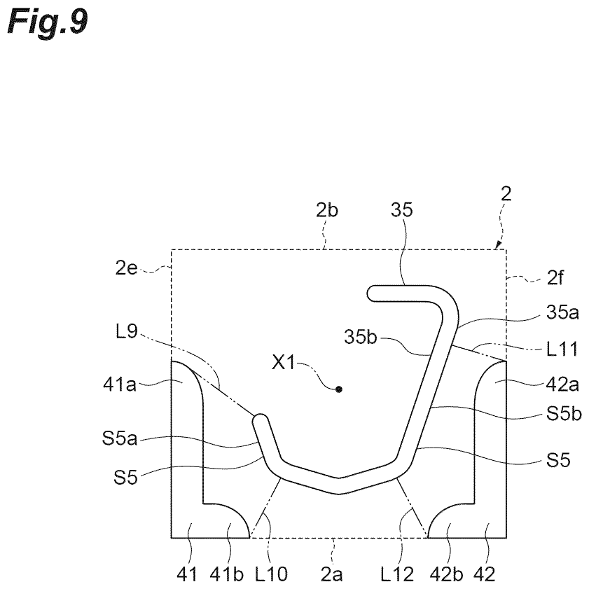

Hereinafter, with reference to FIGS. 2 to 9, each of the coil 3 and the plurality of coil conductors 30 will be described. The coil conductor layers 310 to 370 illustrated in FIG. 6 correspond to the coil conductors 31 to 37 viewed from the direction D1, and each of the electrode layers 410 and 420 corresponds to the external electrodes 41 and 42 viewed from the direction D1. FIG. 7 is a plan view of a first coil conductor according to the present embodiment. FIG. 8 is a plan view of a second coil conductor according to the present embodiment. FIG. 9 is a plan view of a third coil conductor according to the present embodiment.

When viewed from the direction D1, the coil 3 has a pentagonal shape. The pentagon is line-symmetric in the direction D2 with respect to a center line along the direction D3. The pentagon includes a first side located closest to the main surface 2b, a second side located closest to the side surface 2f, a third side and a fourth side located closest to the main surface 2a, and a fifth side located closest to the side surface 2e. The first side and the second side are connected at a first vertex, the second side and the third side are connected at a second vertex, the third side and the fourth side are connected at a third vertex, the fourth side and the fifth side are connected at a fourth vertex, and the fifth side and the first side are connected at a fifth vertex. With respect to a center line passing through the third vertex between the third side and the fourth side, the second side and the fifth side are line-symmetric with each other, and the third side and the fourth side are line-symmetric with each other. The first side is longer than each of the second side and the fifth side. Each of the second side and the fifth side is longer than each of the third side and the fourth side. When viewed from the direction D1, each path of the plurality of coil conductors 30 includes at least one of the first side to the fifth side.

The paths of the coil conductors 31, 34, and 37 include the first side. Path lengths of the coil conductors 31, 34, and 37 are each a ½ turn or less. The paths of the coil conductors 32 and 35 include the second side, the third side, and the fourth side. The paths of the coil conductors 33 and 36 include the third side, the fourth side, and the fifth side. Path lengths of the coil conductors 32, 33, 35 and 36 are each a ½ turn or more. The path lengths of the coil conductors 31 and 37 are equal to each other. The path lengths of the coil conductors 32, 33, 35, and 36 are equal to each other. The coil conductor 34 has a path length shorter than the path length of each of the coil conductors 33 and 35. Each of the coil conductors 33 and 35 has a path length longer than the path length of the coil conductor 34. The coil conductors 33 and 35 may have the longest path length among the plurality of coil conductors 30. The coil conductor 34 may have the shortest path length among the plurality of coil conductors 30.

A portion including the fifth side of the coil conductor 33 is adjacent to the portion 41a of the external electrode 41. A portion of the coil conductor 33 adjacent to the portion 41a of the external electrode 41 has a path length longer than a path length of a portion of the coil conductor 34 adjacent to the portion 41a of the external electrode 41. A portion including the fourth side of the coil conductor 33 is adjacent to the portion 41b of the external electrode 41. The coil conductor 34 does not have a portion adjacent to the portion 41b of the external electrode 41. A portion including the second side of the coil conductor 35 is adjacent to the portion 42a of the external electrode 42. A portion of the coil conductor 35 adjacent to the portion 42a of the external electrode 42 has a path length longer than a path length of a portion of the coil conductor 34 adjacent to the portion 42a of the external electrode 42. A portion including the third side of the coil conductor 35 is adjacent to the portion 42b of the external electrode 42. The coil conductor 34 does not have a portion adjacent to the portion 42b of the external electrode 42.

As illustrated in FIG. 7, the coil conductor 33 includes an outer surface 33a and an inner surface 33b facing each other in the radial direction of the coil 3. In the present embodiment, the radial direction of the coil 3 is orthogonal to the coil axis X1 of the coil 3. As illustrated in FIG. 8, the coil conductor 34 includes an outer surface 34a and an inner surface 34b facing each other in the radial direction. As illustrated in FIG. 9, the coil conductor 35 includes an outer surface 35a and an inner surface 35b facing each other in the radial direction. The outer surfaces 33a, 34a, and 35a are positioned so as to be adjacent to a surface of the element body 2. The inner surfaces 33b, 34b, and 35b are positioned so as to face the coil axis X1. The outer surfaces 33a, 34a, and 35a correspond to a first outer surface, a second outer surface, and a third outer surface, respectively. The inner surfaces 33b, 34b, and 35b correspond to a first inner surface, a second inner surface, and a third inner surface, respectively.

The outer surface 33a includes a region S3 where a perpendicular line perpendicular to the outer surface 33a is drawn from the external electrodes 41 and 42. The region S3 includes a region S3a and a region S3b. A perpendicular line perpendicular to the region S3a may be drawn from the external electrode 41. As illustrated in FIGS. 3 and 7, the region S3a is defined by a perpendicular line L1 from the end of the portion 41a of the external electrode 41 and a perpendicular line L2 from the end of the portion 41b of the external electrode 41. A perpendicular line perpendicular to the region S3b may be drawn from the external electrode 42. As illustrated in FIGS. 4 and 7, the region S3b is defined by a perpendicular line L3 from the end of the portion 42a of the external electrode 42 and a perpendicular line L4 from the end of the portion 42b of the external electrode 42.

The outer surface 34a includes a region S4 where a perpendicular line perpendicular to the outer surface 34a may be drawn from the external electrodes 41 and 42. The region S4 includes a region S4a and a region S4b. A perpendicular line perpendicular to the region S4a may be drawn from the external electrode 41. As illustrated in FIGS. 3 and 8, the region S4a is defined by a perpendicular line L5 from the end of the portion 41a of the external electrode 41 and a perpendicular line L6 from the end of the portion 41b of the external electrode 41. A perpendicular line perpendicular to the region S4b may be drawn from the external electrode 42. As illustrated in FIGS. 4 and 8, the region S4b is defined by a perpendicular line L7 from the end of the portion 42a of the external electrode 42 and a perpendicular line L8 from the end of the portion 42b of the external electrode 42.

The outer surface 35a includes a region S5 where a perpendicular line perpendicular to the outer surface 35a may be drawn from the external electrodes 41 and 42. The region S5 includes a region S5a and a region S5b. A perpendicular line perpendicular to the region S5a may be drawn from the external electrode 41. As illustrated in FIGS. 3 and 9, the region S5a is defined by a perpendicular line L9 from the end of the portion 41a of the external electrode 41 and a perpendicular line L10 from the end of the portion 41b of the external electrode 41. A perpendicular line perpendicular to the region S5b may be drawn from the external electrode 42. As illustrated in FIGS. 4 and 9, the region S5b is defined by a perpendicular line L11 from the end of the portion 42a of the external electrode 42 and a perpendicular line L12 from the end of the portion 42b of the external electrode 42.

The area of the region S4 is smaller than at least one of the area of the region S3 and the area of the region S5. In the present embodiment, the area of the region S4 is smaller than both the area of the region S3 and the area of the region S5. The area of the region S3 is the sum of the area of the region S3a and the area of the region S3b. The area of the region S4 is the sum of the area of the region S4a and the area of the region S4b. The area of the region S5 is the sum of the area of the region S5a and the area of the region S5b.

As described above, the coil conductor 34 has a path length shorter than the path length of each of the coil conductor 33 and the coil conductor 35, and is located between the coil conductor 33 and the coil conductor 35 in the plurality of coil conductors 30. Since the coil conductor 33 and the coil conductor 35 have a path length longer than the path length of the coil conductor 34, the stray capacitance generated between the coil conductor 33 and the coil conductor 35 is larger than the stray capacitance generated between the coil conductor 33 and the coil conductor 35 having other configurations. The interval between the coil conductor 33 and the coil conductor 35 changes based on the thickness of the coil conductor 34. The coil conductor 34 has a thickness larger than the thickness of at least one of the coil conductor 33 and the coil conductor 35. The stray capacitance generated in the coil 3 is smaller than the stray capacitance generated in a coil having a configuration in which the coil conductor 34 has a thickness equal to or less than both the thickness of the coil conductor 33 and the thickness of the coil conductor 35. As a result, the multilayer coil component 1 can improve the self-resonant frequency of the multilayer coil component.

In the multilayer coil component 1, the area of the region S4 of the coil conductor 34 is smaller than at least one of the area of the region S3 of the coil conductor 33 and the area of the region S5 of the coil conductor 35.

The area of the region S3 is an area where the coil conductor 33 and the external electrodes 41 and 42 face each other. The area of the region S4 is an area where the coil conductor 34 and the external electrodes 41 and 42 face each other. The area of the region S5 is an area where the coil conductor 35 and the external electrodes 41 and 42 face each other. Therefore, the stray capacitance generated between the coil conductors 33 to 35 and the external electrodes 41 and 42 changes based on the areas of the regions S3, S4, and S5.

In the multilayer coil component 1, the coil conductor 34 is disposed such that the area of the coil conductor 34 is smaller than at least one of the area of the region S3 of the coil conductor 33 and the area of the region S5 of the coil conductor 35. As compared with a multilayer coil component having a configuration in which the coil conductor 34 is disposed such that the area of the region S4 is equal to or larger than both the area of the region S3 and the area of the region S5, in the multilayer coil component 1, the stray capacitance generated between the coil conductors 33 to 35 and the external electrodes 41 and 42 can be reduced. As a result, the multilayer coil component 1 can further improve the self-resonant frequency of the multilayer coil component.

In the multilayer coil component 1, ends of a pair of coil conductors adjacent to each other among the plurality of coil conductors 30 overlap each other and are coupled to each other.

In a multilayer coil component having another configuration in which ends of a pair of adjacent coil conductors overlap each other and are not coupled to each other, the coil includes another conductor that connects the ends of the pair of adjacent coil conductors. In the multilayer coil component having the other configuration, since the area where the coil 3 and the external electrodes 41 and 42 face each other includes the area where the other conductor and the external electrodes 41 and 42 face each other, the stray capacitance may increase. Since the multilayer coil component 1 having a configuration in which the ends of a pair of coil conductors adjacent to each other overlap each other and are coupled to each other does not include the other conductor, the area in which the coil 3 and the external electrodes 41 and 42 face each other does not include the area in which the other conductor and the external electrodes 41 and 42 face each other. Therefore, in the multilayer coil component 1 having a configuration in which the ends of the pair of coil conductors adjacent to each other overlap each other and are coupled to each other, the stray capacitance can be reduced as compared with the multilayer coil component having the other configuration, so that the self-resonant frequency can be further improved.

In the multilayer coil component 1, the coil conductor 34 may have the largest thickness among the plurality of coil conductors 30.

In the configuration in which the coil conductor 34 has the largest thickness among the plurality of coil conductors 30, since the interval between the coil conductor 33 and the coil conductor 35 is wider than other configurations, the stray capacitance generated between the coil conductor 33 and the coil conductor 35 is further reduced, so that the self-resonant frequency can be further improved.

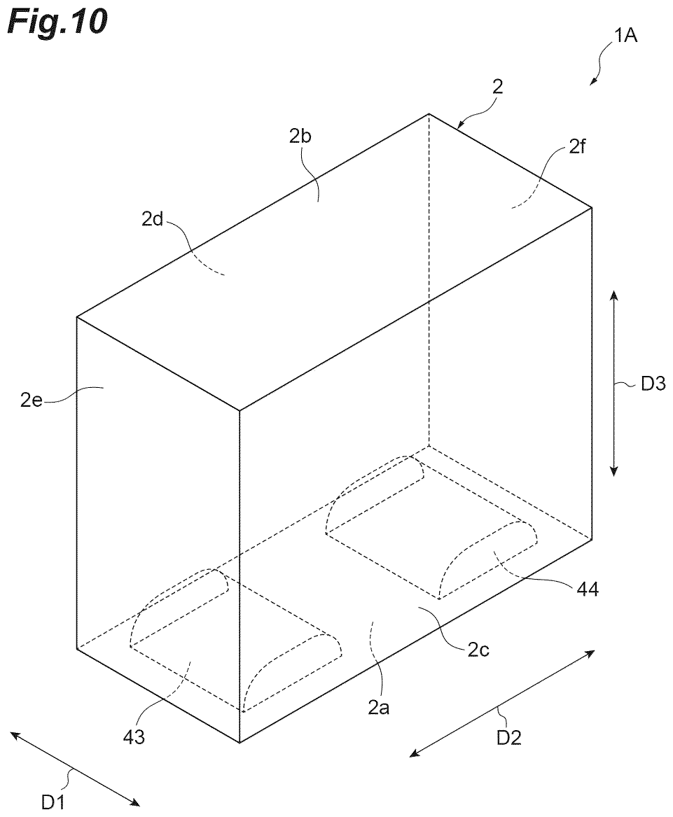

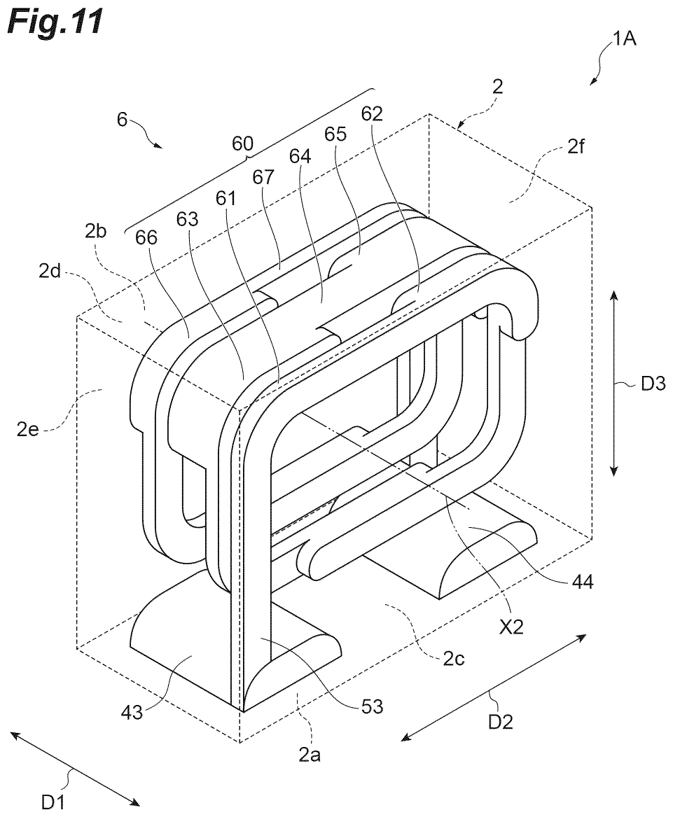

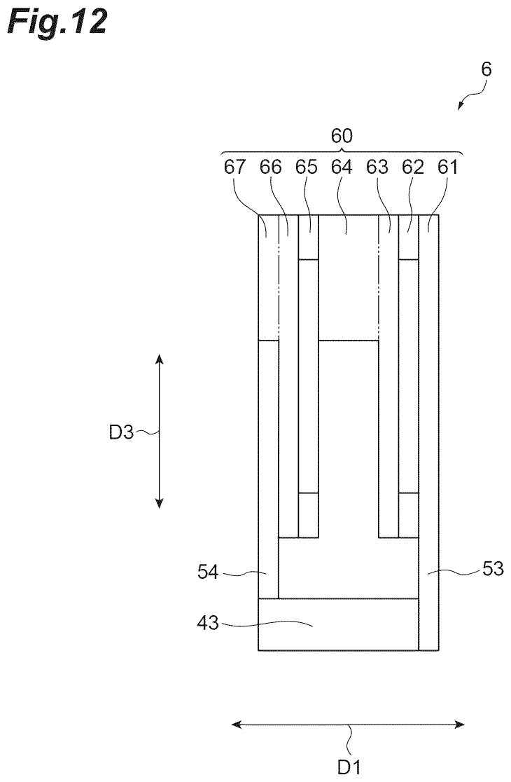

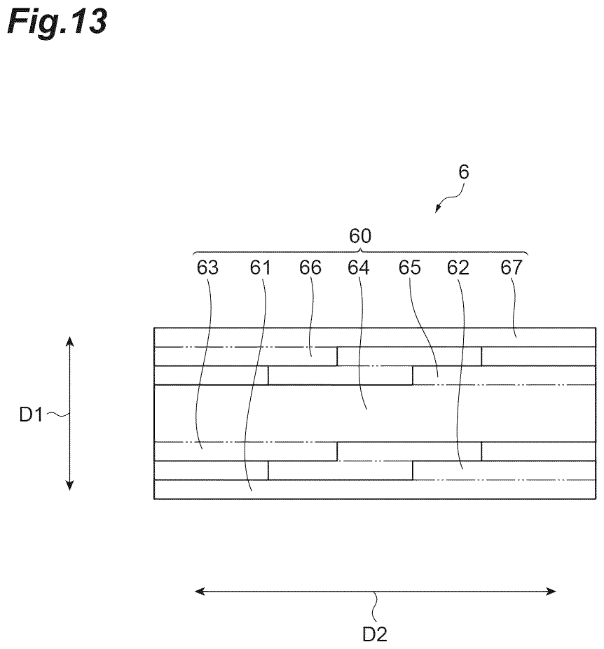

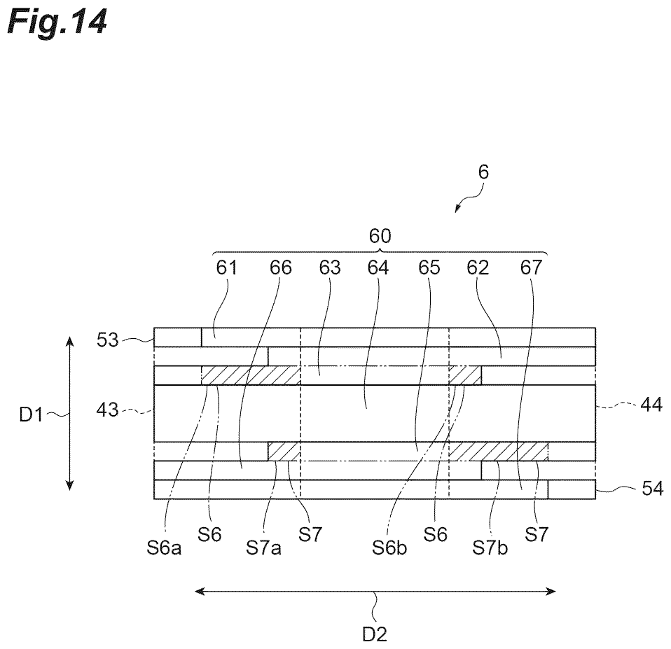

Next, with reference to FIGS. 10 to 14, a configuration of a multilayer coil component 1A according to a modification of the present embodiment will be described. The multilayer coil component 1A according to the modification includes a coil 6, external electrodes 43 and 44, and connection conductors 53 and 54 instead of the coil 3, external electrodes 41 and 42, and the connection conductors 51 and 52. FIG. 10 is a perspective view of a multilayer coil component according to the modification. FIG. 11 is a perspective view of a coil according to the modification. FIG. 12 is a plan view of the coil according to the modification as viewed from a side surface 2e. FIG. 13 is a plan view of the coil according to the modification as viewed from a main surface 2b. FIG. 14 is a plan view of the coil according to the modification as viewed from a main surface 2a. Hereinafter, differences between the embodiment described above and the present modification will be mainly described.

A pair of recesses corresponding to the pair of external electrodes 43 and 44 is formed in the element body 2. The main surface 2a includes a surface defining a recess corresponding to external electrodes 43 and 44. The external electrodes 43 and 44 are disposed only on the main surface 2a among the main surfaces 2a and 2b, the side surfaces 2c and 2d, and the side surfaces 2e and 2f. The surfaces of the external electrodes 43 and 44 face only in the same direction as the main surface 2a among the main surfaces 2a and 2b, the side surfaces 2c and 2d, and the side surfaces 2e and 2f. Surfaces of the external electrodes 43 and 44 and the main surface 2a may be located on the same flat surface. The surfaces of the external electrodes 43 and 44 may protrude from the main surface 2a. The external electrode 43 and the external electrode 44 are arranged away from each other in the direction D2. As viewed from the direction D3, the external electrodes 43 and 44 are positioned away from ridge lines between the main surface 2a and the side surfaces 2c, 2d, 2e and 2f.

As illustrated in FIGS. 11 to 14, a coil 6 includes a plurality of coil conductors 60. The plurality of coil conductors 60 are electrically connected to each other. The plurality of coil conductors 60 includes coil conductors 61, 62, 63, 64, 65, 66, and 67. The coil conductors 61 to 67 are arranged in this order (the coil conductor 61, the coil conductor 62, the coil conductor 63, the coil conductor 64, the coil conductor 65, the coil conductor 66, the coil conductor 67) along the direction D1 and are adjacent to each other. The coil conductor 61 is an endmost coil conductor including one end of the coil 6 in the direction D1. The coil conductor 67 is an endmost coil conductor including the other end of the coil 6 in the direction D1. The coil 6 includes seven coil conductors 61 to 67 coupled in the direction D1. The number of turns of the coil 6 is 2.5. Each of the coil conductors 61 to 67 constitutes a part of an annular track centered on a coil axis X2 in the coil 6.

The coil conductors 63, 64, and 65 are arranged in the direction D1 in the order of the coil conductor 63, the coil conductor 64, and the coil conductor 65. The coil conductor 63 and the coil conductor 64 are adjacent to each other, and the coil conductor 64 and the coil conductor 65 are adjacent to each other. The coil conductor 64 is located between the coil conductor 63 and the coil conductor 65 in the plurality of coil conductors 60. The coil conductor 63 and the coil conductor 65 are separated from each other by the thickness of the coil conductor 64 in the direction D1. Each of the coil conductor 63 and the coil conductor 65 includes a portion facing each other at a distance of the thickness of the coil conductor 64 in the direction D1. For example, the coil conductor 63 is defined as a first coil conductor, the coil conductor 64 is defined as a second coil conductor, and the coil conductor 65 is defined as a third coil conductor.

The thicknesses of the coil conductors 61, 62, 63, 65, 66, and 67 are equal to each other. The coil conductor 64 has a thickness larger than the thickness of the coil conductors 63 and 65. The coil conductor 64 may have a thickness larger than the thickness of at least one of the coil conductor 63 and the coil conductor 65.

The connection conductor 53 connects the coil 6 and the external electrode 43 to each other. The coil 6 and the external electrode 43 are electrically and physically connected to each other via the connection conductor 53. The connection conductor 53 is continuous with the coil conductor 61 in the same layer as the coil conductor 61. The connection conductor 53 extends between the first end of the coil conductor 61 and the external electrode 43. A thickness of the connection conductor 53 is equal to the thickness of the coil conductor 61. The connection conductor 54 connects the coil 6 and the external electrode 44 to each other. The coil 6 and the external electrode 44 are electrically and physically connected to each other via the connection conductor 54. The connection conductor 54 is continuous with the coil conductor 67 in the same layer as the coil conductor 67. The connection conductor 54 extends between the second end of the coil conductor 67 and the external electrode 44. A thickness of the connection conductor 54 is equal to the thickness of the coil conductor 67. Respective thicknesses of the connection conductor 53 and the connection conductor 54 are equal to each other.

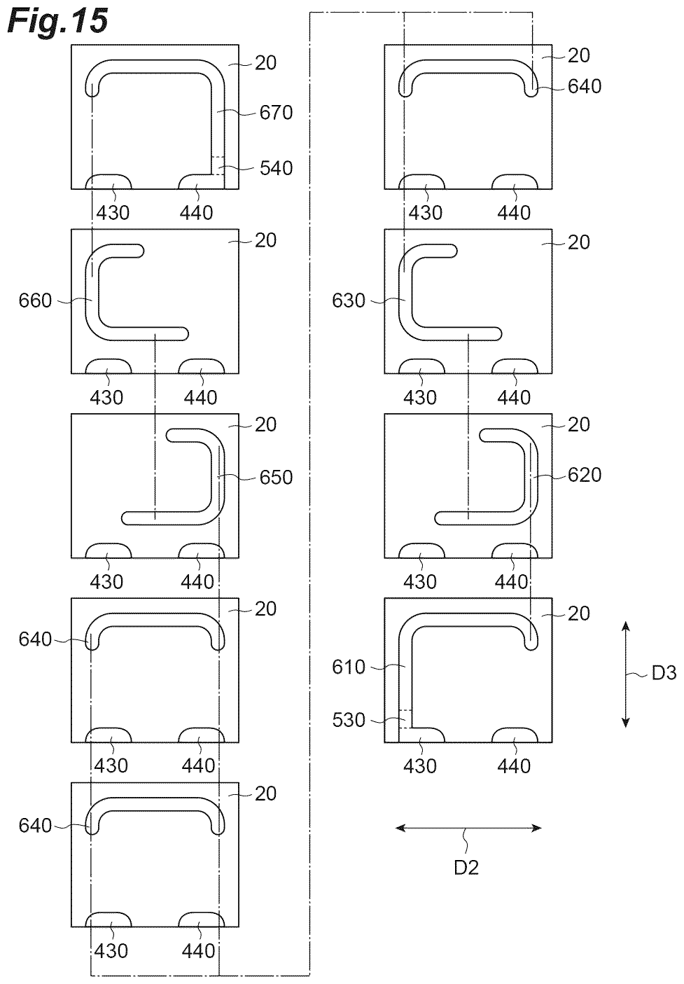

Hereinafter, with reference to FIG. 15, the plurality of coil conductors 60 of the coil 6, the external electrodes 43 and 44, and the connection conductors 53 and 54 will be described. FIG. 15 is an exploded view illustrating a configuration of the multilayer coil component according to the modification.

The external electrode 43 and the external electrode 44 includes a plurality of laminated electrode layers 430 and a plurality of laminated electrode layers 440, respectively. In the present modification, the number of the plurality of electrode layers 430 and the number of the plurality of electrode layers 440 are each “9”. Each of the electrode layers 430 and 440 is provided in a defective portion formed in the corresponding insulator layers 20. A pair of recesses corresponding to the external electrodes 43 and 44 is obtained by the defective portions formed in the respective insulator layers 20. The connection conductor 53 and the connection conductor 54 include an electrode layer 530 and an electrode layer 540, respectively. The electrode layer 530 is continuous with a coil conductor layer 610, and the electrode layer 540 is continuous with a coil conductor layer 670. Each of the electrode layers 530 and 540 is provided in a defective portion formed in the corresponding insulator layers 20. Each of the electrode layer 530 and 540 includes, for example, the same material as that of each of the electrode layers 430 and 440.

The plurality of coil conductors 60 includes a plurality of coil conductor layers corresponding to each of the plurality of coil conductors 60. The coil conductors 61 to 63 include the coil conductor layers 610 to 630, respectively. The coil conductor 64 includes a plurality of coil conductor layers 640 that entirely overlap each other. In the present modification, the number of the plurality of coil conductor layers 640 is “3”. The coil conductors 65 to 67 include the coil conductor layers 650 to 670, respectively.

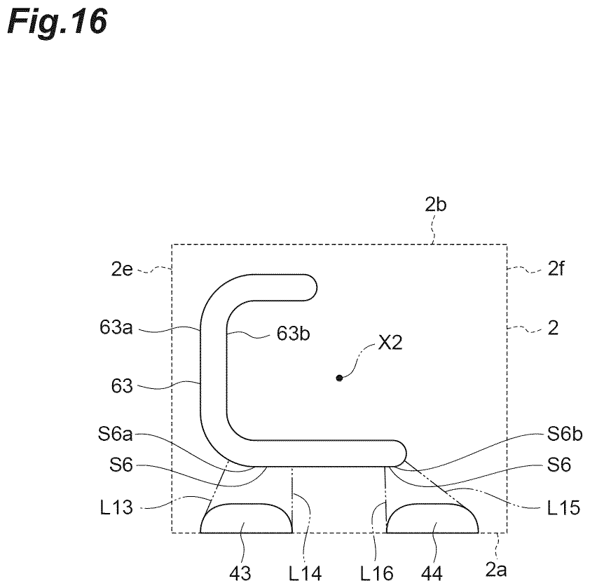

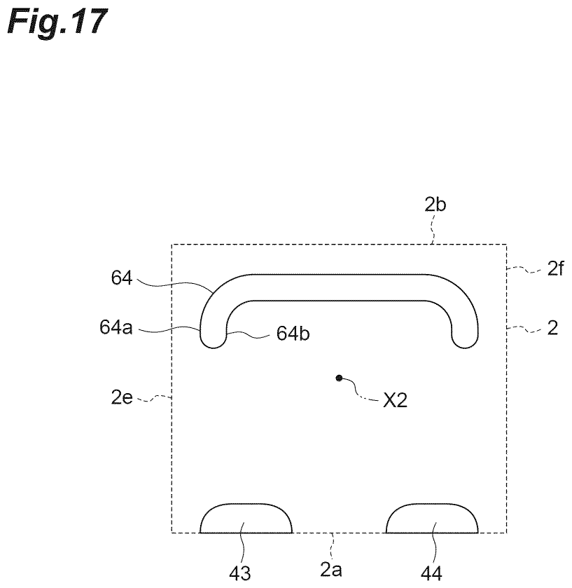

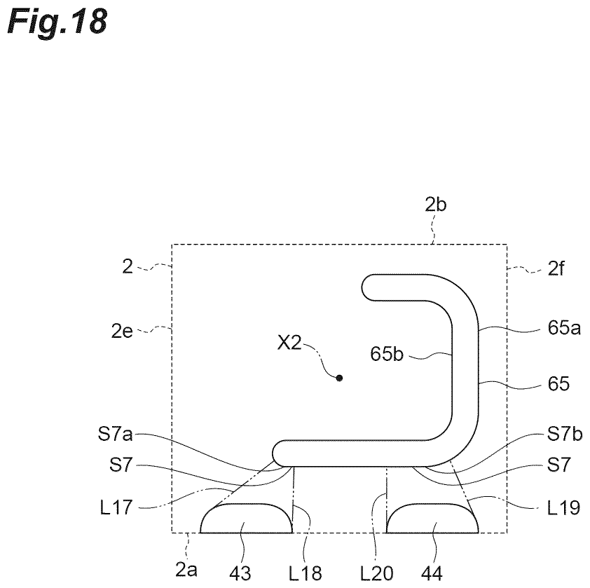

Hereinafter, with reference to FIG. 11 and FIGS. 14 and 18, each of the coil 6 and the plurality of coil conductors 60 will be described. The coil conductor layers 610 to 670 illustrated in FIG. 15 correspond to the coil conductors 61 to 67 viewed from the direction D1, and each of the electrode layers 430 and 440 corresponds to the external electrodes 43 and 44 viewed from the direction D1. FIG. 16 is a plan view of a first coil conductor according to the modification. FIG. 17 is a plan view of a second coil conductor according to the modification. FIG. 18 is a plan view of a third coil conductor according to the modification.

When viewed from the direction D1, the coil 6 has a quadrangular shape. The quadrangle has, for example, a rectangular shape including a pair of long sides along the direction D2 and a pair of short sides along the direction D3. The quadrangle includes a first side located closest to the side surface 2e, a second side located closest to the main surface 2b, a third side located closest to the side surface 2f, and a fourth side located closest to the main surface 2a. The first side and the second side are connected at a first vertex, the second side and the third side are connected at a second vertex, the third side and the fourth side are connected at a third vertex, the fourth side and the first side are connected at a fourth vertex. The first side and the third side are a pair of short sides along the direction D3. The second side and the fourth side are a pair of long sides along the direction D2. Each of the second side and the fourth side is longer than each of the first side and the third side. When viewed from the direction D1, each path of the plurality of coil conductors 60 includes at least one of the first side to the fourth side.

The path of the coil conductor 61 includes the first side and the second side. The paths of the coil conductors 62 and 65 include the third side and the fourth side. The paths of the coil conductors 63 and 66 include the first side and the fourth side. The path of the coil conductor 64 includes the second side. The path of the coil conductor 67 includes the second side and the third side. The path lengths of the coil conductors 61 and 67 are equal to each other. The path lengths of the coil conductors 62, 63, 65, and 66 are equal to each other. The coil conductor 64 has a path length shorter than path lengths of the coil conductors 62, 63, 65, and 66. The coil conductor 64 may have the shortest path length among the path lengths of the plurality of coil conductors 60.

The coil conductors 63 and 65 are disposed around the external electrodes 43 and 44 compared to the coil conductor 64. A portion including the fourth side of the coil conductors 63 and 65 is adjacent to the external electrodes 43 and 44. The coil conductor 64 does not have a portion adjacent to the external electrodes 43 and 44. The shortest distance between the coil conductor 63 and the external electrode 43 is smaller than the shortest distance between the coil conductor 64 and the external electrode 43. The shortest distance between the coil conductor 65 and the external electrode 44 is smaller than the shortest distance between the coil conductor 64 and the external electrode 44. The coil conductors 63 and 65 are disposed closer to the external electrodes 43 and 44 than the coil conductor 64. The coil conductor 64 is arranged away from the external electrodes 43 and 44 more than the coil conductors 63 and 65.

As illustrated in FIG. 16, the coil conductor 63 includes an outer surface 63a and an inner surface 63b facing each other in the radial direction of the coil 6. In the present modification, the radial direction of the coil 6 is orthogonal to the coil axis X2. As illustrated in FIG. 17, the coil conductor 64 includes an outer surface 64a and an inner surface 64b facing each other in the radial direction. As illustrated in FIG. 18, the coil conductor 65 includes an outer surface 65a and an inner surface 65b facing each other in the radial direction. The outer surfaces 63a, 64a, and 65a are positioned so as to be adjacent to the element body 2. The inner surfaces 63b, 64b, and 65b are positioned so as to face the coil axis X2. The outer surfaces 63a, 64a, and 65a correspond to a first outer surface, a second outer surface, and a third outer surface, respectively. The inner surfaces 63b, 64b, and 65b correspond to a first inner surface, a second inner surface, and a third inner surface, respectively.

The outer surface 63a includes a region S6 where a perpendicular line perpendicular to the outer surface 63a may be drawn from the external electrodes 43 and 44. The region S6 includes a region S6a and a region S6b. A perpendicular line perpendicular to the region S6a may be drawn from the external electrode 43. As illustrated in FIGS. 14 and 16, the region S6a is defined by a perpendicular line L13 from the end close to the side surface 2f of the external electrode 43 and a perpendicular line L14 from the end close to the side surface 2e of the external electrode 43. A perpendicular line perpendicular to the region S6b may be drawn from the external electrode 44. As illustrated in FIGS. 14 and 16, the region S6b is defined by a perpendicular line L15 from the end close to the side surface 2f of the external electrode 44 and a perpendicular line L16 from the end close to the side surface 2e of the external electrode 44.

The outer surface 64a does not include a region where a perpendicular line perpendicular to the outer surface 64a may be drawn from the external electrodes 43 and 44. As illustrated in FIGS. 14 and 17, the area of a region where a perpendicular line perpendicular to the outer surface 64a may be drawn from the external electrodes 43 and 44 is zero.

The outer surface 65a includes a region S7 where a perpendicular line perpendicular to the outer surface 65a may be drawn from the external electrodes 43 and 44. The region S7 includes a region S7a and a region S7b. A perpendicular line perpendicular to the region S7a may be drawn from the external electrode 43. As illustrated in FIGS. 14 and 18, the region S7a is defined by a perpendicular line L17 from the end close to the side surface 2f of the external electrode 43 and a perpendicular line L18 from the end close to the side surface 2e of the external electrode 43. A perpendicular line perpendicular to the region S7b may be drawn from the external electrode 44. As illustrated in FIGS. 14 and 18, the region S7b is defined by a perpendicular line L19 from the end close to the side surface 2f of the external electrode 44 and a perpendicular line L20 from the end close to the side surface 2e of the external electrode 44.

The outer surface 64a does not include a region where a perpendicular line perpendicular to the outer surface 64a may be drawn from the external electrodes 43 and 44. Therefore, the area of the region where the perpendicular line perpendicular to the outer surface 64a is drawn from the external electrodes 43 and 44 is smaller than both the area of the region S6 and the area of the region S7. The area of the region S6 is the sum of the area of the region S6a and the area of the region S6b. The area of the region S7 is the sum of the area of the region S7a and the area of the region S7b.

As described above, in the multilayer coil component 1A according to the modification, the element body 2 includes the main surfaces 2a and 2b. The external electrodes 43 and 44 are disposed only on the main surface 2a among the main surfaces 2a and 2b.

As compared with the configuration in which the external electrodes are also disposed on the element body 2 other than the main surface 2a, the configuration in which the external electrodes 43 and 44 are disposed only on the main surface 2a can easily secure the distance between the coil conductor 64 and the external electrodes 43 and 44. Therefore, in the multilayer coil component 1A according to the modification, the stray capacitance generated between the external electrodes 43 and 44 and the coil 6 is further reduced, so that the self-resonant frequency can be further improved.

The present disclosure has been described in detail based on the embodiments. However, the present disclosure is not limited to the above embodiments. The present disclosure can be variously modified without departing from the scope of the present disclosure. The embodiment and the modification can be appropriately combined.

When viewed from the direction D1, the coil 3 may have a polygonal shape other than a pentagonal shape or a quadrangular shape, or may have a circular shape.

For example, the coil conductor 34 does not necessarily have a path length shorter than the path length of each of the coil conductors 33 and 35. For example, it is sufficient that the coil conductor 34 has a thickness larger than the thickness of the coil conductor 33. The coil conductor 33 may include an outer surface 33a and an inner surface 33b facing each other in the radial direction of the coil 3, and the coil conductor 34 may include an outer surface 34a and an inner surface 34b facing each other in the radial direction. The outer surface 33a may include a region S3 where a perpendicular line perpendicular to the outer surface 34a is drawn from the external electrodes 41 and 42. The outer surface 34a may include a region S4 where a perpendicular line perpendicular to the outer surface 34a is drawn from the external electrodes 41 and 42. The area of the region S4 may be smaller than the area of the region S3.

The coil conductor 34 may have a thickness larger than the thickness of at least one of the coil conductor 33 and the coil conductor 35. It is sufficient that the area of the region S4 is smaller than at least one of the area of the region S3 and the area of the region S5.

What is claimed is:

1. A multilayer coil component comprising:
an element body;
a coil in the element body including a plurality of coil conductors each having a thickness and a path length; and
an external electrode on the element body electrically connected to the coil, wherein
the plurality of coil conductors includes a first coil conductor, a second coil conductor, and a third coil conductor, the second coil conductor being positioned between the first coil conductor and the third coil conductor in a direction and being adjacent to the first coil conductor and the third coil conductor, and
the second coil conductor has a path length shorter than a path length of each of the first coil conductor and the third coil conductor, and has a thickness larger than a thickness of at least one of the first coil conductor and the third coil conductor.

2. The multilayer coil component according to claim 1, wherein
the first coil conductor includes a first outer surface and a first inner surface facing each other in a radial direction of the coil,
the second coil conductor includes a second outer surface and a second inner surface facing each other in the radial direction,
the third coil conductor includes a third outer surface and a third inner surface facing each other in the radial direction,
the first outer surface includes a first region where a perpendicular line perpendicular to the first outer surface is drawn from the external electrode,
the second outer surface includes a second region where a perpendicular line perpendicular to the second outer surface is drawn from the external electrode,
the third outer surface includes a third region where a perpendicular line perpendicular to the third outer surface is drawn from the external electrode, and
an area of the second region is smaller than at least one of an area of the first region and an area of the third region.

3. The multilayer coil component according to claim 1, wherein
the element body includes at least one main surface, and
the external electrode is disposed only on one of the at least one main surface.

4. The multilayer coil component according to claim 1, wherein ends of a pair of coil conductors adjacent to each other among the plurality of coil conductors overlap each other and are coupled to each other.

5. The multilayer coil component according to claim 1, wherein the second coil conductor has the thickness that is 1.25 times or more than the thickness of the at least one of the first coil conductor and the third coil conductor.

6. The multilayer coil component according to claim 5, wherein
the first coil conductor includes a first outer surface and a first inner surface facing each other in a radial direction of the coil,
the second coil conductor includes a second outer surface and a second inner surface facing each other in the radial direction,
the third coil conductor includes a third outer surface and a third inner surface facing each other in the radial direction,
the first outer surface includes a first region where a perpendicular line perpendicular to the first outer surface is drawn from the external electrode,
the second outer surface includes a second region where a perpendicular line perpendicular to the second outer surface is drawn from the external electrode,
the third outer surface includes a third region where a perpendicular line perpendicular to the third outer surface is drawn from the external electrode, and
an area of the second region is smaller than at least one of an area of the first region and an area of the third region.

7. The multilayer coil component according to claim 5, wherein
the element body includes at least one main surface, and
the external electrode is disposed only on one of the at least one main surface.

8. The multilayer coil component according to claim 5, wherein ends of a pair of coil conductors adjacent to each other among the plurality of coil conductors overlap each other and are coupled to each other.

9. A multilayer coil component comprising:
an element body;
a coil in the element body including a plurality of coil conductors each having a thickness; and
an external electrode on the element body electrically connected to the coil, wherein
the plurality of coil conductors includes a first coil conductor and a second coil conductor adjacent to each other,
the second coil conductor has a thickness larger than a thickness of the first coil conductor,
the first coil conductor includes a first outer surface and a first inner surface facing each other in a radial direction of the coil,
the second coil conductor includes a second outer surface and a second inner surface facing each other in the radial direction,
the first outer surface includes a first region where a perpendicular line perpendicular to the first outer surface is drawn from the external electrode,
the second outer surface includes a second region where a perpendicular line perpendicular to the second outer surface is drawn from the external electrode, and
an area of the second region is smaller than an area of the first region.

10. The multilayer coil component according to claim 9, wherein
the element body includes at least one main surface, and
the external electrode is disposed only on one of the at least one main surface.

11. The multilayer coil component according to claim 9, wherein ends of a pair of coil conductors adjacent to each other among the plurality of coil conductors overlap each other and are coupled to each other.

12. The multilayer coil component according to claim 9, wherein the second coil conductor has the thickness that is 1.25 times or more than the thickness of the first coil conductor.

13. The multilayer coil component according to claim 12, wherein
the element body includes at least one main surface, and
the external electrode is disposed only on one of the at least one main surface.

14. The multilayer coil component according to claim 12, wherein ends of a pair of coil conductors adjacent to each other among the plurality of coil conductors overlap each other and are coupled to each other.
